(19) United States
(12) Patent Application Publication
(10) Pub. No.: US 2016/0300408 A1
(43) Pub. Date: Oct. 13, 2016

(54) V2X Fuel Economy Data Analysis

(71) Applicant: Ford Global Technologies, LLC, Dearborn, MI (US)

(72) Inventors: Aed M. Dudar, Canton, MI (US); Robert Roy Jentz, Westland, MI (US); Imad Hassan Makki, Dearborn Heights, MI (US); Fling Tseng, Ann Arbor, MI (US)

(21) Appl. No.: 14/684,999

(22) Filed: Apr. 13, 2015

(51) Int. Cl. G07C 5/08; G07C 5/00

(52) U.S. Cl. CPC G07C 5/0816; G07C 5/008

(57) ABSTRACT

A fuel economy data analysis system includes a processor programmed to, in response to receiving signals indicative of a refueling event notification and an estimated fuel economy from a vehicle, and the estimated fuel economy being less than a benchmark, output signals indicative of an alert for the vehicle and a manufacturer of the vehicle indicating that the estimated fuel economy is less than the benchmark.

### TECHNICAL FIELD

The present disclosure relates to systems and methods for providing fuel economy data analysis.

### BACKGROUND

Vehicle fuel economy is one of the metrics used to evaluate performance of a vehicle. When the vehicle fuel economy falls short of the driver's or manufacturer's benchmarks, the driver may become dissatisfied with the vehicle.

The vehicle fuel economy is a result of a variety of factors, such as individual driver vehicle operating habits and vehicle health status, as well as external factors including weather, traffic and quality of gasoline.

### SUMMARY

A fuel economy data analysis system includes a processor that, in response to receiving signals indicative of a refueling event notification and an estimated fuel economy from a vehicle, and the estimated fuel economy being less than a benchmark, outputs signals indicative of an alert for the vehicle and a manufacturer of the vehicle indicating that the estimated fuel economy is less than the benchmark.

A method for analyzing fuel economy data includes, in response to receiving signals indicative of a refueling event notification and an estimated fuel economy from a vehicle, and the estimated fuel economy being less than a benchmark, outputting by a controller signals indicative of an alert for the vehicle and a manufacturer of the vehicle indicating that the estimated fuel economy is less than the benchmark.

A fuel economy data analysis system includes a processor programmed to generate a notification for a manufacturer of a vehicle and to transmit the notification to the manufacturer in response to data received from the vehicle indicating that an estimated fuel economy of the vehicle is less than a benchmark.

### BRIEF DESCRIPTION OF THE DRAWINGS

FIG. 1 is a block diagram illustrating a fuel economy data analysis system;

FIG. 2 is a flowchart illustrating an algorithm for determining fuel content attributes for a refueling station associated with a refueling event;

FIG. 3 is a flowchart illustrating an algorithm for comparing an estimated fuel economy and a historic fuel economy;

FIG. 4 is a flowchart illustrating an algorithm for comparing the estimated fuel economy and a comparable vehicle fuel economy;

FIG. 5A is a set of graphs illustrating average fuel economy for various classes of vehicles;

FIGS. 5B-5C are graphs illustrating fuel economy of compact and midsize vehicles, respectively, at various speeds;

FIGS. 6A-6B are graphs illustrating vehicle speed profile and resulting fuel economy of vehicles A, B, C, and D;

FIGS. 7A-7B are graphs illustrating vehicle speed profile and resulting fuel economy of vehicles E, F, G, and H;

FIG. 8 is a flowchart illustrating an algorithm for determining a vehicle driving pattern; and

FIG. 9 is a flowchart illustrating an algorithm for comparing the estimated fuel economy and a benchmark fuel economy.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Referring to FIG. 1, a fuel economy data analysis system 100 includes a fuel economy data analysis module (FEDAM) 102 capable of communicating with a vehicle 104, a refueling station 106, and a vehicle manufacturer 108. The fuel economy data analysis is indicative of a physical performance of the vehicle 104. The fuel economy data analysis system 100 utilizes vehicle communication technology often referred to as Vehicle-to-Infrastructure (V2X) technology for evaluating vehicle fuel economy. The FEDAM 102 may be located on a remote server, e.g., cloud based server, and may transmit and receive V2X information over a wireless network using any number of data communication protocols, e.g., ITU IMT-2000 (3G), IMT-Advanced (4G), IEEE 802.11a/b/g/n (Wi-Fi), WiMax, ANT™, ZigBee®, Bluetooth®, Near Field Communications (NFC), and others.

The vehicle 104 detects a refueling event when a driver adds fuel to a vehicle fuel tank and notifies the FEDAM 102 that the refueling event has been detected. For example, an engine control module (ECM) (not shown) of the vehicle 104 may detect the refueling event in response to receiving a fuel level increase signal from a fuel level sensor (not shown). The ECM is capable of communicating with a vehicle data bus (e.g., a CAN bus) that provides access to various other vehicle modules, such as a telematics module (not shown) that in turn has access to an in-vehicle information and is able to communicate with off-board servers. The telematics module of the vehicle 104 transmits the refueling event notification to the FEDAM 102.

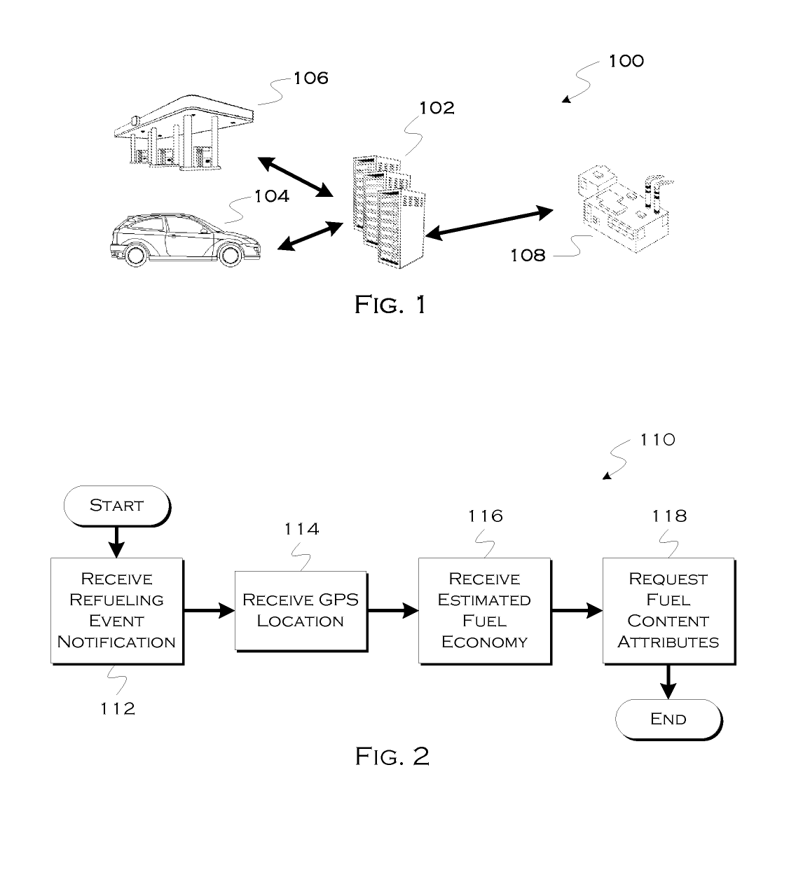

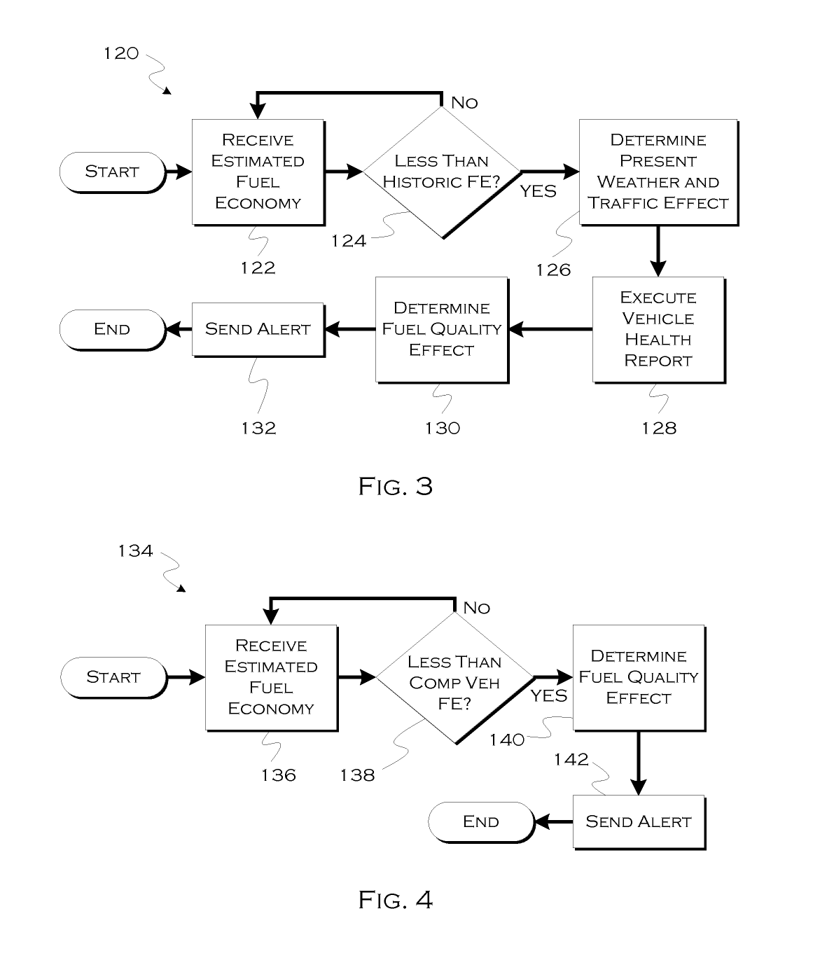

In reference to FIG. 2, a control strategy 110 for evaluating fuel economy data is shown. As mentioned previously in reference to FIG. 1, the control strategy 110 may begin at block 112 where the FEDAM 102 receives the refueling event notification from the vehicle 104. At a time of the refueling event, as shown at block 114, the FEDAM 102 receives a Global Positioning System (GPS) location of the refueling station 106 associated with the refueling event. For example, the telematics module may incorporate a GPS receiver and other sensors for detecting a geographic location of the vehicle 104. In another example, the FEDAM 102 may receive the GPS location of the refueling station 106 from the refueling station 106. In a further example, the FEDAM 102 may apply a process of reverse geocoding to a set of GPS coordinates to determine the GPS location of the refueling station 106.

At block 116, the FEDAM 102 further receives an estimated fuel economy of the vehicle 104. For example, the estimated fuel economy may be an instant or an average value reflecting a relationship between distance covered and a fuel amount used by the vehicle 104. The estimated fuel economy may be measured in miles-per-gallon (MPG) or other units and may be based on inputs from a fuel control module (FCM), the ECM, and other vehicle modules.

At block 118, the FEDAM 102, in response to receiving the refueling event notification, requests fuel content attributes from the refueling station 106. For example, the FEDAM 102 may use V2X technology to communicate with a refueling station communication module. In another example, the fuel content attributes may include a fuel brand, e.g., Shell™ Mobile™, BP™, etc., a fuel type, e.g., gasoline, diesel, ethanol, bio-diesel, etc., and an octane rating, e.g., E85, E87, E88, E89, etc. At this point the control strategy 110 may end. In some embodiments the control strategy 110 described in FIG. 2 may be repeated in response to receiving a refueling event notification or another notification or request.

In reference to FIG. 3, a control strategy 120 for evaluating the fuel economy data is shown. The control strategy may begin at block 122 where the FEDAM 102 receives the estimated fuel economy of the vehicle 104. At block 124, the FEDAM 102 determines whether the estimated fuel economy is less than historic fuel economy of the vehicle 104. For example, the FEDAM 102 may compare the estimated fuel economy and fuel economy the vehicle 104 had reported in previous refueling events. If the estimated fuel economy is more than the historic fuel economy, the FEDAM 102 returns to block 122. In other scenarios, the FEDAM 102 sends an alert for the vehicle 104 indicating that the estimated fuel economy is greater than the historic fuel economy.

If the estimated fuel economy is less than the historic fuel economy, the FEDAM 102 determines effect of present weather and traffic on the estimated fuel economy at block 126. For example, the FEDAM 102 may use V2X technology to receive present weather from a weather station (not shown). The FEDAM 102 may further receive traffic information from a variety of sources, such as commercial traffic data providers, departments of transportation, police and emergency services, road sensors, traffic cameras, etc. The FEDAM 102 analyzes contribution of the present weather and traffic to the estimated fuel economy being less than the historic fuel economy of the vehicle 104.

At block 128, the FEDAM 102 executes a vehicle health report for the vehicle 104. For example, the vehicle health report may be a report generated by a vehicle monitoring system configured to receive diagnostic, maintenance, and recall information pertaining to the vehicle 104. For example, in executing the vehicle health report the FEDAM 102 may use information pertaining to tire pressure monitoring (TPM), fuel delivery, after-treatment, ignition, throttle control, air control, and catalyst systems and subsystems to report diagnostics for any relevant sensors such as a universal exhaust gas oxygen (UEGO) sensor, heated exhaust gas oxygen (HEGO) sensor, air mass flow sensor, fuel pressure regulator, variable camshaft timing (VCT), exhaust gas recirculation (EGR), exhaust gas oxygen (EGO) sensors, and other temperature and pressure sensors in these and relevant subsystems. The FEDAM 102 may indicate in the vehicle health report the effect of present vehicle diagnostic, maintenance, and recall conditions on the estimated fuel economy.

The FEDAM 102 determines effect of fuel quality on the estimated fuel economy at block 130. For example, the FEDAM 102 may use the fuel content attributes received from the refueling station 106 to determine the effect of the fuel quality on the estimated fuel economy. The FEDAM 102 may, for example, reference estimated fuel economy reported by other vehicles in communication with the FEDAM 102 refueling at the refueling station 106.

The FEDAM 102 sends an alert for the vehicle 104 and a vehicle manufacturer 108 indicating that the estimated fuel economy is less than the historic fuel economy at block 132. For example only, the FEDAM 102 may indicate the effect of the present weather and traffic conditions, as well as, the effect of the vehicle diagnostic, maintenance, and recall conditions on the estimated fuel economy.

In sending the alert, the FEDAM 102 may further indicate the effect of the fuel quality on the estimated fuel economy. For example in response to determining that following refueling events at the refueling station 106 other vehicles report decreased estimated fuel economy, the FEDAM 102 may indicate in the alert that the fuel quality at the refueling station 106 may be having a negative effect on the estimated fuel economy. The FEDAM 102 may further send an alert to the refueling station 106 indicating that at least one vehicle reported decreased estimated fuel economy after refueling there.

Additionally, in response to determining that following refueling events at the refueling station 106 vehicles report decreased estimated fuel economy, the FEDAM 102 may periodically broadcast to the vehicles in communication therewith that the fuel quality at the refueling station 106 may have a negative effect on the estimated fuel economy. At this point the control strategy 120 may end. In some embodiments the control strategy 120 described in FIG. 3 may be repeated based on receiving a refueling event notification or another notification or request.

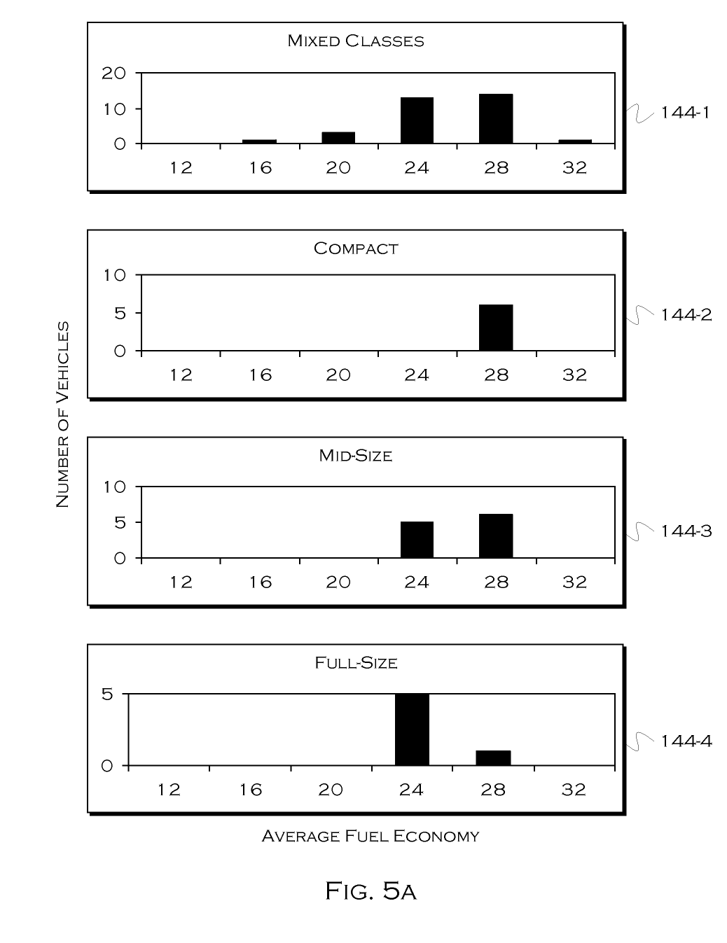

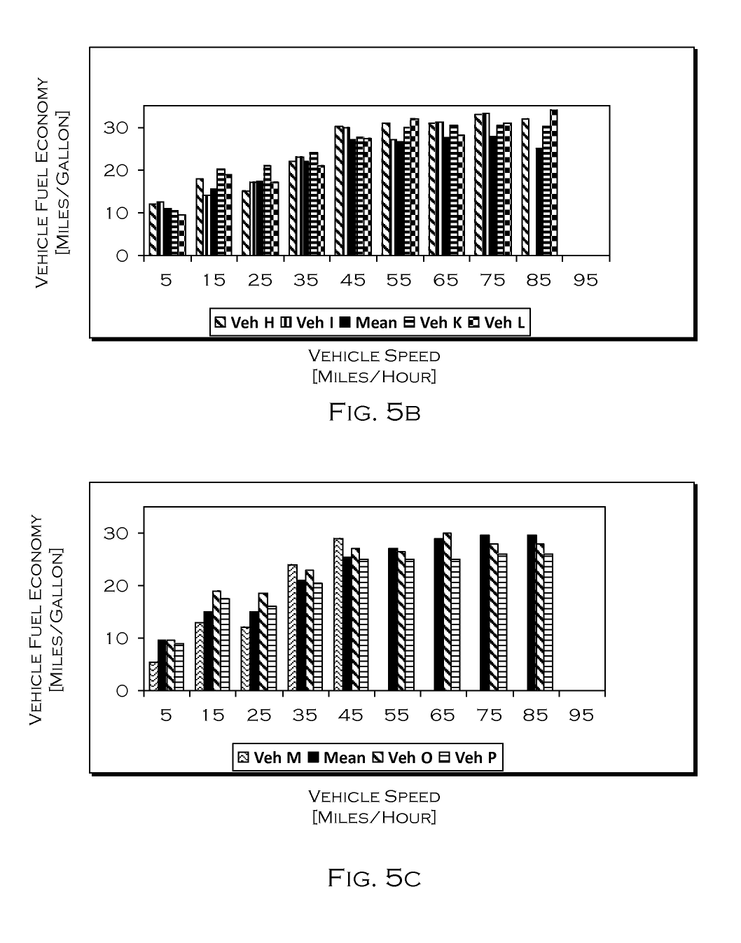

Referring to FIG. 4, a control strategy 134 for analyzing fuel economy data with respect to a comparable vehicle is shown. The control strategy 134 may begin at block 136 where the FEDAM 102 receives the estimated fuel economy from the vehicle 104. As will be discussed in further detail in reference to FIGS. 5A-C, 6A-B, 7A-B and 8, the FEDAM 102 determines, at block 138, whether the estimated fuel economy is less than a comparable vehicle fuel economy. The FEDAM 102 returns to block 136 if the estimated fuel economy is more than the comparable fuel economy. In other scenarios, the FEDAM 102 sends an alert for the vehicle 104 indicating that the estimated fuel economy is greater than the comparable vehicle fuel economy.

At block 140, the FEDAM 102 determines, in response to the estimated fuel economy being less than the comparable vehicle fuel economy, the effect of fuel quality on the estimated fuel economy. For example only, the FEDAM 102 may use the fuel content attributes received from the refueling station 106 to determine the effect of the fuel quality on the estimated fuel economy. The FEDAM 102 may determine that the comparable vehicles that refuel at a refueling station other than the refueling station 106 have an improved fuel economy.

The FEDAM 102 sends an alert for the vehicle 104 and the vehicle manufacturer 108, at block 142. The FEDAM 102 may indicate in the alert that the estimated fuel economy is less than the comparable vehicle fuel economy. The FEDAM 102 may further indicate that the comparable vehicles that refuel at a refueling station other than the refueling station 106 have an improved fuel economy. The FEDAM 102 may further send an alert for the refueling station 106 indicating that at least one vehicle reported decreased estimated fuel economy after refueling there. At this point the control strategy 134 may end. In some embodiments the control strategy 134 described in FIG. 4 may be repeated based on receiving a refueling event notification or another notification or request.

The comparable vehicle may be a vehicle of the same production year, make, and model as the vehicle 104. The comparable vehicle may further be a vehicle of the same segment as the vehicle 104, e.g., Environmental Protection Agency (EPA) class (two-seater, minicompact, subcompact, compact, mid-size, etc.) and National Highway Traffic Safety Administration (NHTSA) class (mini, light, compact, medium, heavy, sports utility vehicle (SUV), etc.) among others. FIG. 5A shows example fuel economy profiles for a small sample of vehicles across several classes 144-1, vehicles in a compact class 144-2, e.g., Ford Focus, vehicles in a midsize class 144-3, e.g., Ford Fusion, and vehicles in a full-size class 144-4, e.g., Ford Taurus.

In another example, the FEDAM 102 may determine a mean fuel economy for a set of speed bands, such as 5 miles/hour (mph), 15 mph, 25 mph, etc. Shown in FIGS. 5B-5C are a compact class and a midsize class fuel economy profiles, respectively, where patterned columns each indicate a mean fuel economy of a particular vehicle in a given speed band and solid-color columns indicate a mean fuel economy for the same speed band. The FEDAM 102 may further limit the comparable vehicle to be a vehicle that travels in the same locale as the vehicle 104 and/or a vehicle that uses the same refueling stations as the vehicle 104.

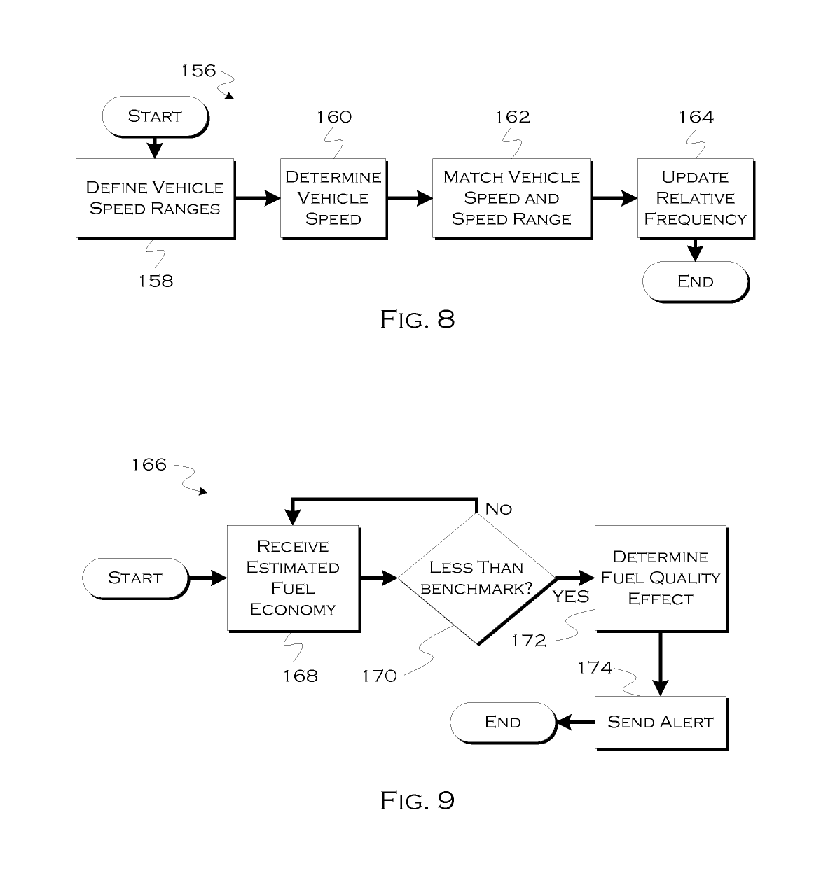

In a further example, the FEDAM 102 may determine whether a vehicle is a comparable vehicle based on recursive frequency estimation analysis of relevant vehicle driving patterns, such as speed profile, acceleration profile, grade profile, effective mass profile, and operating ambient temperature profile. The FEDAM 102 may use an algorithm as outlined in reference to FIG. 8 to determine the relevant vehicle profiles. For example, the FEDAM 102 may use a one-dimensional (1D) matrix for each relevant driving pattern. In an alternative example, the FEDAM 102 may use an n-dimensional (ND) matrix to combine two or more relevant driving patterns.

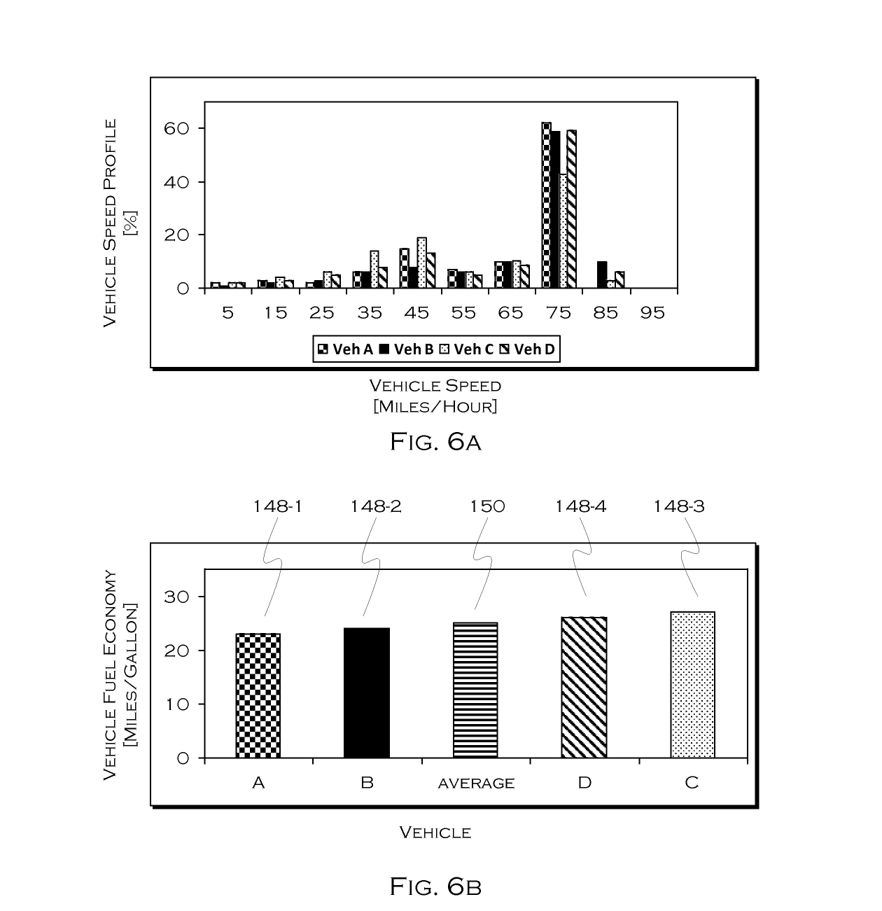

Shown in FIG. 6A is a Vehicle B speed profile, where solid-color columns indicate a vehicle B speed in given speed bands. The FEDAM 102 may identify vehicles A, C, and D (shown by corresponding patterned columns) as having speed profiles that are comparable to the Vehicle B, such that, for example, all four vehicles spend approximately 60% of their driving cycle moving at a highway speed of 75 mph. For example, the FEDAM 102 may determine the comparable vehicles using divergence formulae, such as a vector difference, a cosine similarity function, a Kullback-Leibler divergence, or any machine learning method known in the art.

The FEDAM 102 may determine, as shown in FIG. 6B, an average fuel economy 150 of the vehicles A, B, C, and D based on fuel economy 148-1, 148-2, 148-3, and 148-4 of each of the vehicles, respectively. For example, the FEDAM 102 may determine that the average fuel economy 150 is 25.8 mph. The FEDAM 102 may further determine that the Vehicle B fuel economy 148-2 is 25.1 mph and is less than the average fuel economy 150 of the comparable vehicles A, C, and D. As mentioned in reference to FIG. 4, the FEDAM 102 may then send an alert for the Vehicle B indicating that the Vehicle B fuel economy 148-2 is less than the comparable vehicle fuel economy.

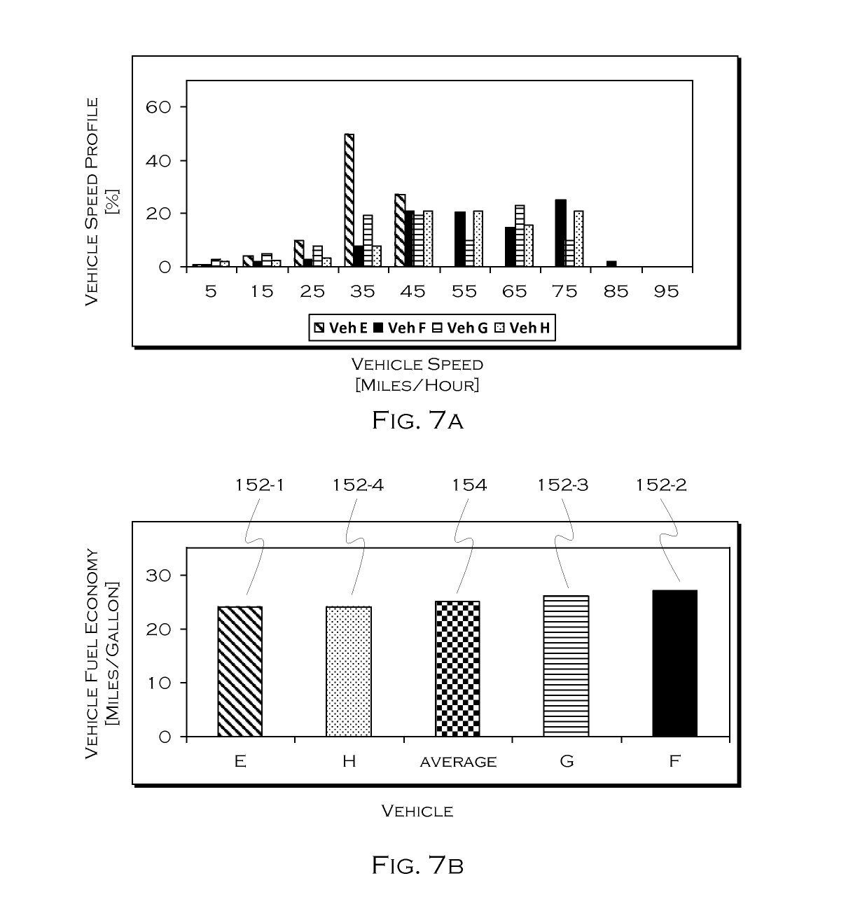

In reference to FIG. 7A, a Vehicle F speed profile is shown where solid-color columns show a vehicle F speed in each of a given speed band. The FEDAM 102 may identify vehicles E, G, and H (shown by corresponding patterned columns) as having speed profiles that are comparable to the Vehicle F, such that, for example, all four vehicles spend approximately 40% of their driving cycle moving at highway speeds and 40% of their driving cycle moving at city traffic speeds.

As shown in FIG. 7B, the FEDAM 102 may determine an average fuel economy 154 of the vehicles E, F, G, and H based on fuel economy 152-1, 152-2, 152-3, and 152-4 of each of the vehicles, respectively. For example, the FEDAM 102 may determine that the average fuel economy 154 is 25.3 mph. The FEDAM 102 may further determine that the Vehicle F fuel economy 152-2 is 26.6 mph and is greater than the average fuel economy 154 of the comparable vehicles E, G, and H. As mentioned in reference to FIG. 4, the FEDAM 102 may then send an alert for the Vehicle F indicating that the Vehicle F fuel economy 152-2 is greater than the comparable vehicle fuel economy.

Referring to FIG. 8, a control strategy 156 for determining the relevant vehicle driving patterns, such as speed and acceleration profiles, is shown. The control strategy 156 may begin at block 158 where the FEDAM 102 defines one or more vehicle speed ranges including a lower and an upper speed, e.g., 0-20 mph, 21-40 mph, 41-60 mph, etc. The FEDAM 102 determines vehicle speed of the vehicle 104 at block 160. For example, the FEDAM 102 may receive the vehicle speed from the telematics module via the V2X technology. At block 162 the FEDAM 102 matches the vehicle speed with at least one of the speed ranges. For example, in response to determining that the vehicle speed, V_{spd}, equals 20 mph, the FEDAM 102 may set a first speed range, x₀₋₂₀, to 1 and set second, third, and fourth speed ranges, x₂₁₋₄₀, x₄₁₋₆₀, x₆₁₋₈₀, respectively, to zero.

The FEDAM 102 updates relative frequency of the vehicle speed in a given speed range at block 164. The FEDAM 102 may, for example, update the relative frequency by applying digital signal processing (DSP), such as an exponential smoothing function, and use it to predict a next most likely vehicle speed. The FEDAM 102 may use a smoothing factor having a value between 0 and 1 to control a number of the vehicle speed values stored in a given speed range based on time or distance the vehicle 104 is driven. At this point the control strategy 156 may end. In some embodiments the control strategy 156 described in FIG. 8 may be repeated in response to receiving a refueling event notification or another notification or request.

In reference to FIG. 9, a control strategy 166 for analyzing fuel economy data with respect to a benchmark fuel economy is shown. The control strategy 166 may begin at block 168 where the FEDAM 102 receives the estimated fuel economy from the vehicle 104. The FEDAM 102 determines, at block 170, whether the estimated fuel economy is less than the benchmark fuel economy. For example, the benchmark fuel economy may be fuel economy established by the EPA and marketed by the vehicle manufacturer via a window sticker on a new vehicle. Further for example, the benchmark fuel economy may be a fuel economy goal set by the driver of the vehicle 104. If the estimated fuel economy is more than the benchmark fuel economy the control returns to block 168. In other scenarios, the FEDAM 102 sends an alert for the vehicle 104 indicating that the estimated fuel economy is greater than the benchmark fuel economy.

At block 172, in response to the estimated fuel economy being less than the benchmark fuel economy, the FEDAM 102 determines the effect of the fuel quality on the estimated fuel economy. For example, the FEDAM 102 may use the fuel content attributes received from the refueling station 106 to determine the effect of the fuel quality on the estimated fuel economy. The FEDAM 102 may determine that the vehicles that refuel at a refueling station other than the refueling station 106 have fuel economy that is equal to or greater than the benchmark fuel economy.

The FEDAM 102, at block 174, sends an alert for the vehicle 104 and the vehicle manufacturer 108 indicating that the estimated fuel economy is less than the benchmark fuel economy. For example, the FEDAM 102 may indicate in the alert that the vehicles that refuel at a refueling station other than the refueling station 106 have fuel economy that is equal to or greater than the benchmark fuel economy. The FEDAM 102 may further send an alert for the refueling station 106 indicating that at least one vehicle reported decreased estimated fuel economy after refueling there. At this point the control strategy 166 may end. In some embodiments the control strategy 166 described in FIG. 9 may be repeated in response to receiving a refueling event notification or another notification or request.

The control strategies 110, 120, 134, 156, and 166 described in FIGS. 2, 3, 4, 8 and 9, respectively, may evaluate contribution of each known factor separately and in combination in order to provide the most accurate information for the vehicle and the manufacturer. Fuel economy data analysis may further be useful in alerting other drivers in the vicinity of a particular refueling station that a known gasoline quality at that refueling station may either positively or negatively affect their estimated fuel economy.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A fuel economy data analysis system comprising:
a processor programmed to, in response to receiving signals indicative of a refueling event notification and an estimated fuel economy from a vehicle, and the estimated fuel economy being less than a benchmark, output signals indicative of an alert for the vehicle and a manufacturer of the vehicle indicating that the estimated fuel economy is less than the benchmark.

2. The fuel economy data analysis system of claim 1, wherein the processor is further programmed to, in response to receiving the signals indicative of the refueling event notification, output signals indicative of a request for fuel content attributes from a refueling station associated with the refueling event notification.

3. The fuel economy data analysis system of claim 2, wherein the processor is further programmed to periodically broadcast signals indicative of information derived from the fuel content attributes for vehicles in communication therewith.

4. The fuel economy data analysis system of claim 3, wherein the information represents a contribution of the fuel content attributes to fuel economy estimates for the vehicle.

5. The fuel economy data analysis system of claim 1, wherein the processor is further programmed to, in response the estimated fuel economy being less than the benchmark, output signals indicative of a request for weather conditions along a route to a refueling station associated with the refueling event notification.

6. The fuel economy data analysis system of claim 1, wherein the processor is further programmed to, in response to the estimated fuel economy being less than the benchmark, output signals indicative of a request for a traffic report along a route to a refueling station associated with the refueling event notification.

7. The fuel economy data analysis system of claim 1, wherein the processor is further programmed to, in response to receiving the signals indicative of the refueling event notification and the estimated fuel economy from the vehicle, and the estimated fuel economy being less than a historic fuel economy of the vehicle, output signals indicative of an alert for the vehicle and the manufacturer of the vehicle indicating that the estimated fuel economy is less than the historic fuel economy.

8. The fuel economy data analysis system of claim 7, wherein the alert for the vehicle and the manufacturer of the vehicle is based on a vehicle health report.

9. The fuel economy data analysis system of claim 1, wherein the processor is further programmed to, in response to receiving the signals indicative of the refueling event notification and the estimated fuel economy from the vehicle, and the estimated fuel economy being less than an average fuel economy of comparable vehicles, output signals indicative of an alert for the vehicle and the manufacturer of the vehicle indicating that the estimated fuel economy is less than the average fuel economy of the comparable vehicles.

10. The fuel economy data analysis system of claim 9, wherein the comparable vehicles are vehicles of a same class as the vehicle.

11. A method for analyzing fuel economy data comprising:
in response to receiving signals indicative of a refueling event notification and an estimated fuel economy from a vehicle, and the estimated fuel economy being less than a benchmark, outputting by a controller signals indicative of an alert for the vehicle and a manufacturer of the vehicle indicating that the estimated fuel economy is less than the benchmark.

12. The method of claim 11 further comprising, in response to receiving the signals indicative of the refueling event notification, outputting signals indicative of a request for fuel content attributes from a refueling station associated with the refueling event notification.

13. The method of claim 12 further comprising periodically broadcasting signals indicative of information derived from the fuel content attributes for vehicles in communication therewith.

14. The method of claim 13, wherein the information represents a contribution of the fuel content attributes to fuel economy estimates for the vehicle.

15. The method of claim 11 further comprising, in response to the estimated fuel economy being less than the benchmark, outputting signals indicative of a request for weather conditions along a route to a refueling station associated with the refueling event notification.

16. The method of claim 11 further comprising, in response to the estimated fuel economy being less than the benchmark, outputting signals indicative of a request for a traffic report along a route to a refueling station associated with the refueling event notification.

17. The method of claim 11 further comprising, in response to receiving the signals indicative of the refueling event notification and the estimated fuel economy from the vehicle, and the estimated fuel economy being less than a historic fuel economy of the vehicle, outputting signals indicative of an alert for the vehicle and the manufacturer of the vehicle indicating that the estimated fuel economy is less than the historic fuel economy.

18. The method of claim 11 further comprising, in response to receiving the signals indicative of the refueling event notification and the estimated fuel economy from the vehicle, and the estimated fuel economy being less than an average fuel economy of comparable vehicles, outputting signals indicative of an alert for the vehicle and the manufacturer of the vehicle indicating that the estimated fuel economy is less than the average fuel economy.

19. A fuel economy data analysis system comprising:
a processor programmed to generate a notification for a manufacturer of a vehicle and to transmit the notification to the manufacturer in response to data received from the vehicle indicating that an estimated fuel economy of the vehicle is less than a benchmark.

20. The fuel economy data analysis system of claim 19, wherein the notification includes the estimated fuel economy.
